(19) United States
(12) Patent Application Publication
(10) Pub. No.: US 2009/0283386 A1
(43) Pub. Date: Nov. 19, 2009

(54) SYSTEM TO AUTOMATICALLY MOVE PHYSICAL INFRASTRUCTURE TO OPTIMIZE GEOTHERMAL COOLING

(75) Inventors: Vincent V. Diluoffo, Sandy Hook, CT (US); Michael D. Kendzierski, New York, NY (US); Christopher J. Dawson, Arlington, VA (US); Rick A. Hamilton, II, Charlottesville, VA (US)

Correspondence Address: Weitzman Law Offices LLC, 425 Eagle Rock Avenue, Suite 102, Roseland, NJ, 07068, US

(73) Assignee: INTERNATIONAL BUSINESS MACHINES CORPORATION, Armonk, NY (US)

(21) Appl. No.: 12/121,727

(22) Filed: May 15, 2008

(51) Int. Cl. B65G 29/02

(52) U.S. Cl. 198/468.8

(57) ABSTRACT

A system for selectively moving computer equipment to a naturally cooled underground data center. In one aspect of this disclosure, the system includes at least one movable pod for mounting computer equipment. The pod is electrically connected to a power and communications source to provide power and communications to the computer equipment mounted in the pod. The pod is mounted on a vertical conveyor that is driven by a motor to selectively move the pod to and from the underground data center.

### BACKGROUND

1. Field of the Invention

This disclosure relates generally to cooling systems and, more particularly, to a system for optimized geothermal cooling of computer infrastructure.

2. Description of Related Art

Computer data centers must be adequately cooled to operate efficiently in order to reduce hardware failures attributable to changes in temperature and humidity. Typically, HVAC equipment is utilized to effectively cool the computer equipment within such data centers. Such HVAC equipment is typically powered by electricity or fossil fuels and operation of such HVAC equipment can be expensive.

It is desirable to reduce the dependency on such HVAC equipment, electricity and fossil fuels for cooling equipment within a data center.

### BRIEF SUMMARY

In one aspect of this disclosure, a system is disclosed for selectively moving computer equipment to a naturally cooled underground data center. The system includes at least one movable pod for mounting computer equipment. The pod is electrically connected to a power and communications source to provide power and communications to the computer equipment mounted in the pod. The pod is mounted on a vertical conveyor that is driven by a motor to selectively move the pod to and from the underground data center.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWING

This disclosure is further described in the detailed description that follows, with reference to the drawing, in which:

FIG. 1 illustrates an exemplary movement mechanism for positioning pods containing computer equipment underground for constant geothermal cooling; and

FIG. 2 illustrates another exemplary movement mechanism for positioning pods containing computer equipment underground for constant geothermal cooling.

### DETAILED DESCRIPTION

This application discloses a system for selectively moving computer or IT infrastructure systems into a naturally cooled data center below ground for constant underground geothermal cooling. Underground geothermal systems are currently used for transferring a temperature of approximately 45° F.-58° F. for heating and cooling systems. The system disclosed herein takes advantage of this natural underground cooling effect using a movement mechanism that transports pods containing computer and IT infrastructure by semi-automatic and automatic operation to and from a data center buried beneath the Earth's surface. Computer and IT infrastructure can, therefore, be raised or lowered into a naturally cooled underground data center based on necessary cooling requirements, and can be raised above ground for human interaction and/or maintenance. Utilization of this natural underground geothermal cooling reduces the dependency on HVAC equipment, electricity and fossil fuels for the operation of data centers or the like.

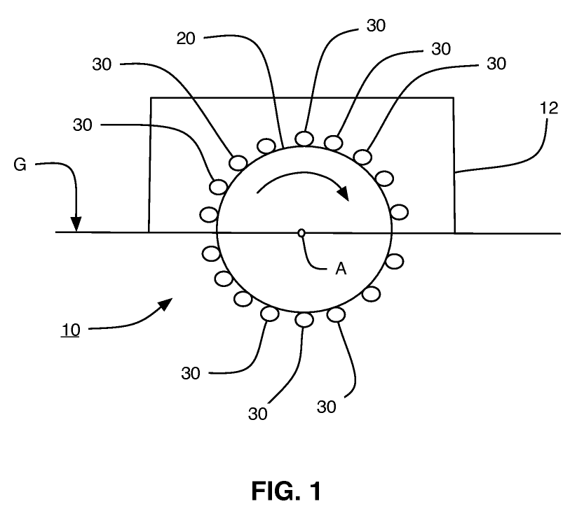

Referring to FIG. 1, a system is illustrated for selectively moving computer or IT infrastructure below ground to a naturally cooled data center for constant underground geothermal cooling. The system includes a movement mechanism 10 capable of lowering and raising one or more pods 30 into an underground location. The underground data center is preferably located a distance of approximately 100-500 feet below ground level G, where the ambient temperature is between approximately 45° F.-58° F.

The movement mechanism 10 may be a Ferris wheel-like structure comprising a large upright wheel 20 that is rotatably supported at ground level G so that it can support the weight loads associated with each of the pods 30 and their respective computer equipment. Alternatively, the wheel 20 may be of a non-circular geometry, such as, for example, an oval or the like. The wheel 20 preferably rotates on a central, horizontal axle A supported by a base (not shown) at ground level G within an enclosure or other structure 12 for protecting the computer infrastructure from the environment.

The wheel 20 is preferably driven by one or more motors coupled to a gear box or transmission (not shown). The motor movement (and associated rotation of the wheel 20) may be controlled by a computerized controller executing software commands, which transmits a signal causing the motor to turn in the clockwise or counterclockwise direction. The signal transmitted by the controller to the drive motor automatically positions a particular pod 30 in its optimal location so that the computer infrastructure in that pod can perform its scheduled job.

Each pod 30 is a physical structure for supporting computer equipment within itself. A pod 30 is a set of infrastructure components that are tightly-coupled together to provide the core services necessary to operate computer operating system with other networked systems. The tightly-coupled services include, but are not limited to, power connectivity, networking connectivity and storage connectivity. These services are tightly-coupled together and provide the “life-line” for connectivity for systems within a networked environment. These services may be fed from below or above the floor and provide enough physical length to move the pods around the data center and not lose any connectivity from the core services. The pod 30 may have a number of different configurations, including, for example, 19 inch rack mounted equipment or capable of supporting standalone servers in compartments.

Each pod 30 would preferably support at least two types of connectors-power and communications (e.g., network cabling such as Ethernet (RJ45) or wireless (802.11x)), which would be fed through the movement mechanism 10 and wheel 20. In addition, for redundancy purposes, it is preferred that there be at least two sets of connectors per pod 30.

Each pod 30 is securely attached to the rotatable wheel 20 of the movement mechanism 10, such as, for example, by utilizing a latch with a locking pin. Multiple latches may be spread across the length of the pod 30 to evenly distribute the weight load associated with the computer infrastructure contained in the pod. Other conventional techniques for permanently and/or releasably attaching the pods 30 to the wheel 20 may also be utilized.

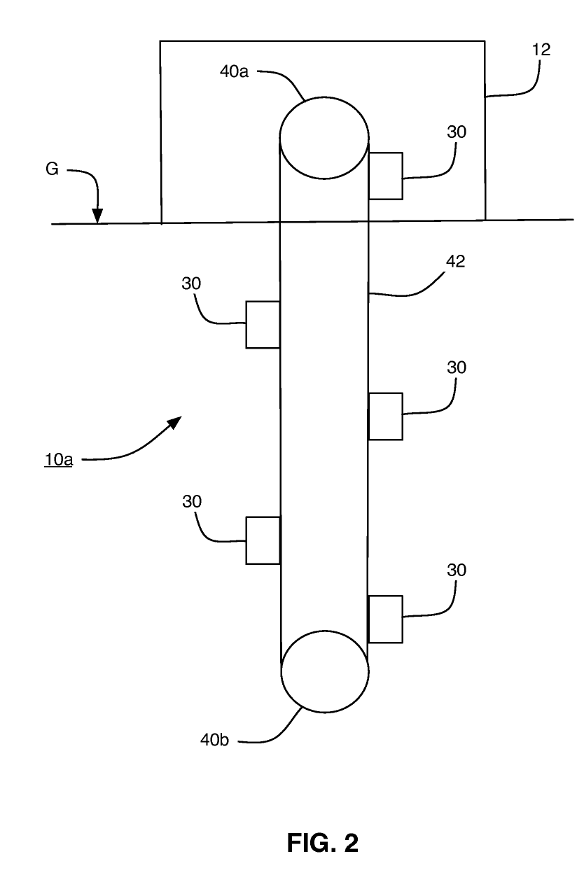

FIG. 2 illustrates another embodiment of a movement mechanism 10a for positioning pods 30 containing computer equipment underground for constant geothermal cooling. The movement mechanism 10a may be a vertical conveyor or the like having at least one upper gear or pulley 40a that is rotatably supported at ground level G within a within an enclosure or other structure 12 for protecting the computer infrastructure from the environment.

The movement mechanism 10a may also include at least one lower gear or pulley 40b that is located at a desired depth for the underground data center, which may be, for example, a distance of approximately 100-500 feet below ground level G, where the ambient temperature is between approximately 45° F.-58° F.

Each pod 30 is securely attached to a movable belt 42 of the movement mechanism 10a, such as, for example, by utilizing a latch with a locking pin. Multiple latches may be spread across the length of the pod 30 to evenly distribute the weight load associated with the computer infrastructure contained in the pod. Other conventional techniques for permanently and/or releasably attaching the pods 30 to the belt 42 may also be utilized.

The movable belt 42 engages the gears 40a, 40b such that rotation of the gears causes the belt to move as well. The belt 42 may alternatively be one or more chains or cables to which the pods 30 are secured. Similarly, the gears 40a, 40b may alternatively be rotatable pulleys that engage and move the belt 42.

The gears 40a, 40b may be rotatably mounted on a base (not shown) and are preferably driven by one or more motors coupled to a gear box or transmission (not shown). The motor movement (and associated rotation of the gears 40a, 40b) may be controlled by a computerized controller executing software commands, which transmits a signal causing the motor to turn in the clockwise or counterclockwise direction. The signal transmitted by the controller to the drive motor automatically positions a particular pod 30 in its optimal location so that the computer infrastructure in that pod can perform its scheduled job.

While the movement mechanism 10 has been described above as utilizing a rotatably driven Ferris wheel-like structure 20 or a vertical conveyor 10a, it is understood that the present disclosure is not limited solely to these specific structures and that other movement mechanisms may be utilized for raising and lowering computer equipment into a naturally cooled underground data center. For example, one or more elevators or pulley systems may be utilized to selectively move pods containing computer equipment to and from the naturally cooled underground data center. Similarly, other types of known vertical conveyors may be utilized with the present disclosure for raising and lowering pods of computer equipment into a naturally cooled underground data center.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

1. A system for selectively moving computer servers to a naturally cooled underground data center, comprising:
at least one movable pod for mounting a computer server, the pod electrically connected to a power and communications source to provide power and communications to the computer server mounted in the pod;
a vertical conveyor on which the pod is mounted, the vertical conveyor driven by a motor to selectively move the pod to and from the underground data center; and
an electrical connection, routed through the vertical conveyor to accommodate motion, which transmits power and communications from the power and communications source to the pod.
